(19) United States
(12) Patent Application Publication
(10) Pub. No.: US 2014/0118270 A1
(43) Pub. Date: May 1, 2014

(54) SYSTEM AND METHOD FOR PROVIDING INFRARED GESTURE INTERACTION ON A DISPLAY

(71) Applicant: QUALCOMM INCORPORATED, San Diego, CA (US)

(72) Inventors: Daniel Moses, San Diego, CA (US); Robert Mitchell Kleiman, San Diego, CA (US); Milivoje Aleksic, San Diego, CA (US)

(73) Assignee: QUALCOMM INCORPORATED, San Diego, CA (US)

(21) Appl. No.: 13/779,201

(22) Filed: Feb. 27, 2013

Related U.S. Application Data
(60) Provisional application No. 61/719,268, filed on Oct. 26, 2012.
(60) Provisional application No. 61/749,192, filed on Jan. 4, 2013.

(51) Int. Cl. G06F 3/041

(52) U.S. Cl. CPC G06F 3/041
USPC 345/173

(57) ABSTRACT

Systems, methods, and apparatus for a touch sensitive display device providing infrared gesture capture and recognition are described. A display device with a detachable front panel is capable of interactive touch sensing and infrared gesture capture and processing. An infrared light source and infrared camera can be configured to capture images of complex multi-touch gestures made on the detachable front panel of the device. The detachable front panel may be removed from the display device for cleaning and ease of use.

### CROSS-REFERENCE TO RELATED APPLICATIONS

The application claims the priority benefit of U.S. Provisional Application No. 61/719,268, entitled “SYSTEM AND METHOD FOR PROVIDING INFRARED GESTURE INTERACTION ON A DISPLAY,” filed Oct. 26, 2012, and U.S. Provisional Application No. 61/749,192, entitled “SYSTEM AND METHOD FOR PROVIDING INFRARED GESTURE INTERACTION ON A DISPLAY,” filed Jan. 4, 2013, the entireties of which are incorporated herein by reference.

### TECHNICAL FIELD

The devices, systems and methods disclosed herein relate generally to user interfaces for electronic devices, and more particularly to infrared gesture recognition using touch sensing displays for electronic devices.

### BACKGROUND

Touch sensing displays are a popular interface on electronic devices, allowing users to easily enter commands and data. Touch displays can be found in mobile devices, electronic displays, tablets, laptops, and desktop computers. Touch displays are generally designed to operate and respond to a finger touch, stylus touch, finger movement, or stylus movement on the touch screen surface.

Touching a specific point on the touch display may activate a virtual button, feature, or function found or shown at that location on the touch display. Typical features may include, for example, making a phone call, entering data, opening or closing a browser window, among other functions.

In some environments, the touch screen may be unable to accurately resolve a complicated user gesture, such as a multi-touch entry. This inaccuracy may be a result of a lack of sensitivity within touch sensors on the display, or due to the complexity of the multi-touch entry from the user.

Additionally, certain electronic devices, such as mobile phones, can have relatively small displays which limit the amount of motion by a user on the touch screen. In certain instances, it can be difficult for a user to input complex commands by touching the display screen.

### SUMMARY

The systems, methods, and devices of the present disclosure each have several innovative aspects, no single one of which is solely responsible for the desirable attributes disclosed herein.

One embodiment is a system for interactive gesture recognition that has an infrared light source and a camera mounted behind a display. In some embodiments, the system may further have a detachable front panel, which also provides complex touch interaction using the infrared camera and pressure sensors. Some embodiments of the detachable front panel may comprise bezel-less glass. In environments where the display device is exposed to dirt or grease, having no bezel provides the benefit of preventing the dirt or grease from collecting at contact lines between a bezel and the glass, which can be difficult to completely clean from the glass. The detachable nature of the front panel allows a user to comfortably use the display in a messy environment, as the front panel may be removed for cleaning while the display itself remains untouched by dirt or grease. Further, in environments where the display may become scratched or damaged, having a detachable panel to protect the display extends the life of the display by having an easily replaceable component exposed to the damage.

Another embodiment is a touch-sensitive display device that includes a touchscreen having a front and a back and capable of detecting a user's touch, one or more infrared lights configured to illuminate a user's finger placed in front of the touchscreen, an infrared camera positioned behind the touchscreen and configured to capture infrared images of a user's finger through the touchscreen, and a gesture processing module configured to determine a user's touch on the touchscreen and track the position of the user's finger, wherein the gesture processing module determines a user's gesture from the determined touch and position tracking.

Yet another embodiment is a system to capture user gestures on a touch-sensitive display device that includes a touchscreen having a front and back and capable of detecting a user's touch, one or more infrared lights configured to illuminate a user's finger placed in front of the touchscreen, and an infrared camera positioned behind the touchscreen and configured to capture infrared images of a user's finger through the touchscreen. The system further includes a control module configured to activate a gesture recognition module when a user touches the touchscreen, capture one or more images of user gestures made on the touchscreen of the touch-sensitive display device, deactivate the gesture recognition module when a user releases the touchscreen, and analyze the images of user gestures to perform a corresponding action on the display.

One other embodiment is a touch-sensitive display device that includes a touchscreen having a front and a back and capable of detecting a user's touch, means for providing an infrared light when a user touches the touchscreen, means for capturing one or more images of a user's gestures made on the touchscreen of the touch-sensitive display device, means for deactivating the infrared light and discontinuing capture of images of user gestures when a user releases the touchscreen, and means for analyzing the images of user gestures to perform a corresponding action on the display.

Still another embodiment is a method for inputting data into a touch-sensitive electronic device that includes the steps of detecting pressure from a user touch on the touch-sensitive device, activating an infrared light unit when a user touch is detected, capturing one or more images of a user gestures made on the touch-sensitive display device, and analyzing the images of user gestures to perform a corresponding action on a display of the touch-sensitive electronic device.

One other embodiment is a non-transitory computer-readable storage medium that has instructions that when executed by a processor perform a method of inputting data into a touch-sensitive electronic device. The method includes the steps of detecting pressure from a user touch on the touch-sensitive device, activating an infrared light unit when a user touch is detected, capturing one or more images of a user gestures made on the touch-sensitive display device, and analyzing the images of user gestures to perform a corresponding action on a display of the touch-sensitive electronic device.

### BRIEF DESCRIPTION OF THE DRAWINGS

The disclosed aspects will hereinafter be described in conjunction with the appended drawings and appendix, provided to illustrate and not to limit the disclosed aspects, wherein like designations denote like elements.

FIG. 1 is a schematic of a touch sensitive display system and apparatus with a detachable front panel, according to one implementation.

FIG. 2 is a front perspective view of a touch sensitive display device, according to one implementation

FIG. 3 is a top view of a touch sensitive display device having an infrared camera.

FIG. 4A is a schematic drawing of the underside of a detachable front panel of the touch sensitive display device of FIG. 2.

FIG. 4B is a schematic drawing of the display device of FIG. 2 with the front panel detached.

FIG. 5 is a schematic cross sectional view of the display device of FIG. 2.

FIG. 6 is a schematic cross sectional view of infrared gesture capture incorporated into the display device of FIG. 2.

FIG. 7 is a schematic block diagram depicting a touch sensitive display system implementing some operative elements.

FIG. 8 is a flow chart illustrating a touch sensing and infrared gesture processing process, according to one implementation.

FIG. 9 is a flow chart illustrating an infrared gesture capture and recognition process, according to one implementation.

### DETAILED DESCRIPTION

Embodiments relate to the use of imaging systems to input information into an electronic system. In one embodiment, implementations include systems, devices, methods, or apparatus that utilize an infrared imaging system to capture the motion of a user's fingers and use that motion to provide touch-based input on a display screen. This provides for a touch-sensitive display device with infrared multi-touch interactive gesture recognition.

For example, in one embodiment, the device may have a display panel that is transparent to infrared light, but displays information from an attached electronic system. Such displays may include LCD or LED display panels. An infrared camera and light source, as discussed below, may be positioned behind the display panel, opposite from the user and focused to capture motion in front of the display panel. As the user moves a finger, or set of fingers, in front of the display panel, the infrared camera may capture the signature of the user's fingers and analyze that signature to determine which gestures are currently being performed. Software running within the electronic system may be used to analyze the user's finger motion to determine the proper gesture being performed.

In one embodiment, the display may include a frame holding the display panel that is used to display information to a user from an attached electronic system. The display panel may be covered by a removable, transparent panel that may be secured to the frame using magnets or other means for holding the panel in place. The infrared light source and infrared camera may be positioned behind the display panel and transparent panel and used to provide recognition and interpretation of the user's complex multi-touch gestures. A plurality of pressure sensors may be attached to the frame so that movement of the transparent panel with respect to the display produces a pressure sensor signal that is analyzed to determine a location of a user's touch. This touch signal can be used to determine when the system should initiate capture of a touch gesture using the infrared camera. Thus, in use, the system scans to detect pressure on the transparent panel from the pressure sensors on the frame. When pressure is detected, the system calculates the coordinate position of the pressure event on the screen to localize where the finger press has occurred. The system then initializes the infrared image sensor and light to monitor the movement of the finger from the detected position. By monitoring this movement, the system can track complex finger movements, even across a transparent panel that does not have integrated touch sensors, but instead uses pressure sensors to detect finger position. In some embodiments, the removable transparent panel is a bezel-less glass panel.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

### Display Device Overview

Embodiments of the invention relate to touch-sensitive devices having a detachable front panel wherein pressure sensors placed on the display and an infrared (“IR”) camera placed behind the display provide interactive touch sensing and gesture recognition. One exemplary device is described in U.S. Provisional Application No. 61/749,184, entitled “INTERACTIVE DISPLAY WITH REMOVABLE FRONT PANEL,” filed on Jan. 4, 2013, the entirety of which is incorporated herein by reference. Infrared gesture recognition functions may be provided on a touch-sensitive display device as illustrated in the described embodiments. In other embodiments, infrared gesture recognition may be provided on other electronic devices such as but not limited to a laptop, desktop, or mobile devices.

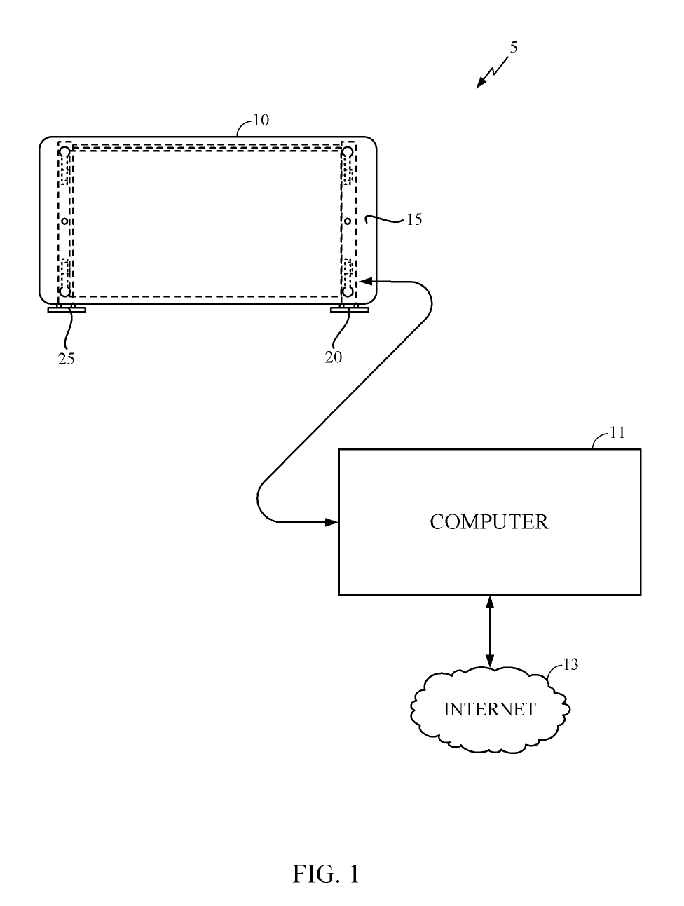

FIG. 1 illustrates one embodiment of a touch sensitive display system 5 having a bezel-less, detachable transparent front panel 15 mounted on a frame structure (not shown) that is supported by legs 20, 25. The touch sensitive display system 5 is configured to display information to a user. As shown, the display 10 may be wire or wirelessly connected to a computer 11, such as a laptop, desktop or other processing device that is configured to display content to the user on the display 10. In some embodiments, computer 11 may be integrated into the display 10. The system 5 may also be wire or wirelessly connected to a wide area network 13, such as the Internet, via computer 11, in order to download content to the display 10 and upload user input from the touch sensitive display 10. The display 10 can include an infrared light source and an infrared camera (not shown), and can be configured to operate using recognition of multi-touch gestures, as will be described in further detail herein. A user can provide input to the system 5 using multi-touch gestures which may be captured by the camera and correlated with known user command gestures. Additionally, a user can provide input into to the display system 5 using, for example, a virtual keyboard. The input can include, for example, text, numbers, symbols, and/or control commands.

As shown in FIG. 1, the display 10 is a standalone display device. However, other devices suitable for communication with a network may be used. The display device 10 in connection with computer 11 can be used to transmit information to and receive information from other devices over the Internet 13. The information communicated can include, for example, voice, data, and/or multimedia services. The display device 10 and computer 11 can also be used to communicate over networks besides the Internet 13, including, for example, cellular networks.

The computer 11 and display device 10 can communicate using a variety of standards. For example, certain user devices can communication according to IEEE 16.11 standard, including IEEE 16.11(a), (b), or (g), or the IEEE 802.11 standard, including IEEE 802.11a, b, g or n. In some embodiments, the user device can include an antenna for transmitting and receiving RF signals according to the BLUETOOTH standard. For certain user devices, such as when the user device is a mobile phone, the user device can communicate using an antenna designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology.

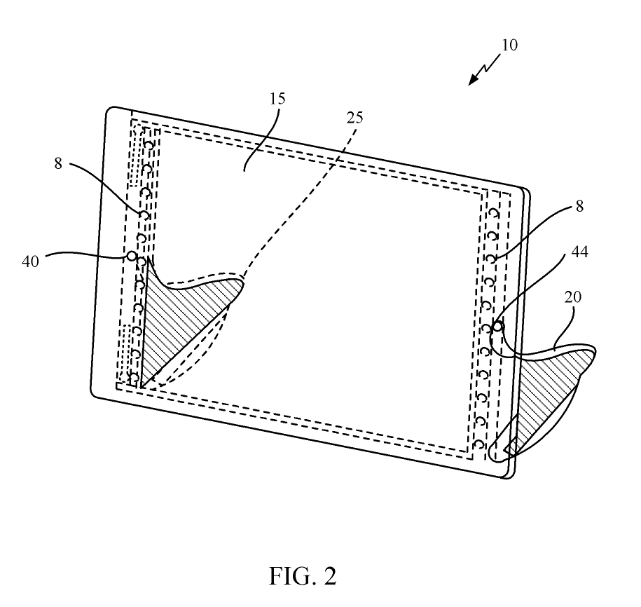

FIG. 2 shows a perspective view of one embodiment of the touch sensitive display device 10 with the detachable front panel 15. The display device 10 is supported by a frame 16 which is constructed from two legs 20 and 25 coupled to a back panel of glass (not shown). The legs 20 and 25 may be coupled to the back panel of glass by mechanical fasteners or by a bonding agent such as glue. An active display panel 17 provides the actual display of pixels that displays information to the user from a connected electronic system such as the computer 11, smart phone, or tablet. The active display panel 17 is positioned over the back panel of glass. The active display panel 17 can be any kind of flat panel technology, such as a transparent LCD display. In some configurations, the active display panel 17 may be a 22 inch Samsung LTI220MT02 display with the bezel removed.

The transparent front panel 15 may be coupled to the frame 16 such that it entirely covers the active display panel 17. The front panel 15 may be made out of a transparent, high transmittance, nearly tint-free glass, and preferably comprises one substantially flat planar surface with no bezel. For example, in one configuration the front panel 15 may be made of Starphire glass, also known as Eurowhite, Opti White or Diamante, having a length of about 600 mm, height of about 340 mm, and thickness of about 3.3 mm. The front panel 15 may be detachably secured to the display panel 17 by a magnetic coupling between the front panel 15 and the legs 20 and 25 of the frame. This magnetic coupling may include a pair of magnets 40, 44 bonded to the underside of the front panel 15 within shallow grooves having a depth approximately equal to one half the thickness of the magnets 40, 44. The magnets 40, 44 are further configured to mount to matching magnetic holders (not shown) disposed in central positions within each leg 20 and 25. The placement of the magnets 40, 44 within the shallow grooves helps to align the magnets 40, 44 with corresponding magnets disposed in the legs 20, 25 and also helps to remove some load from the bonding agent holding the magnets to the front panel 15. The magnetic coupling of the front panel 15 to the display device 10 may also be achieved through a combination of magnets and a magnetically attractive material. This magnetic coupling allows the front panel 15 to be easily removed from the attached position in front of the active display panel 17 to be washed after use.

Infrared light units 8 may be located on the legs 20 and 25 of the device 10, as shown in FIG. 2. The infrared light units 8 direct light towards the front of the display 10, that is, toward the user. In some configurations, the infrared light units 8 are a wide angled light source attached to the front face of either or both legs of the device 10. In one configuration, the infrared light units 8 may be infrared LED light units that emit light of about 850 nm wavelength. The infrared light may pass directly through the transparent active display panel 17 and the front panel 15 without interference, and therefore, in other configurations, the infrared light units 8 may be placed behind the display 10, within an electronics housing, to direct infrared light through the transparent display toward the user.

The reflection of infrared light from a user's hand or fingers may be captured by an infrared camera (not shown) located behind the display 10. These images of a user's gestures may be analyzed using gesture processing functions to determine an intended user command gesture. These features are discussed in greater detail below.

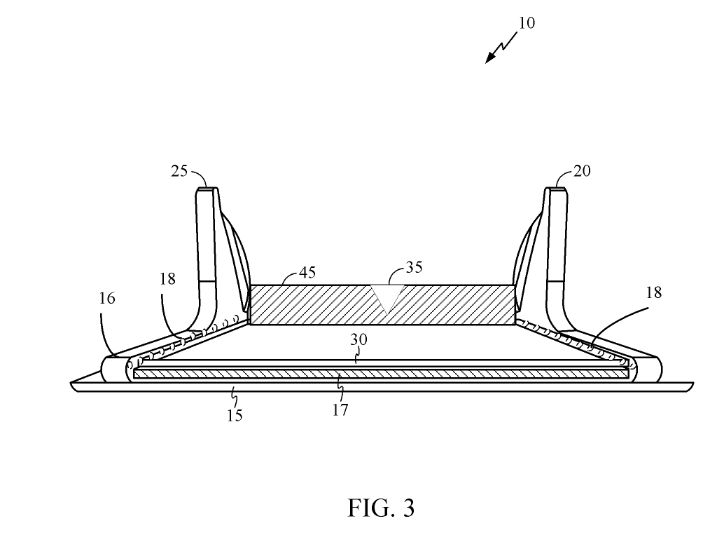

As shown in the top view FIG. 3, the front panel 15 is mounted directly adjacent the active display panel 17. The front panel 15 may have a larger width and height than the active display panel 17 and the back panel 30 so that it protrudes to the sides and above the frame 16. In some configurations, labels showing common measuring equivalents such as those used in cooking may be etched on the sides of the front panel 15 to provide useful information to the user. By being placed on the sides of the front panel 15 they may not overlap the active display panel 17 and obstruct a user's view of the information shown on the display. The front panel 15 may be larger than the underlying panels in order to facilitate easy grasping and removal of the front panel 15 for cleaning. In some configurations, the display device 10 has a thickness of approximately 1 inch between the front of the front panel 15 and the back of the back panel 30. In other configurations, the display device has a thickness of approximately 20 mm or ⅘ of an inch. In still further configurations, the display device may have a thickness of approximately ½ of an inch.

The legs 20 and 25 may be integrated into the back panel 30 or they may be bonded to the back panel 30. In some configurations, the legs 20 and 25 may be made of Plexiglas Acrylic or other rigid plastic to provide support and stability for the display device 10. The legs 20 and 25 may be approximately one inch in width or they may be other widths sufficient to securely support the weight of the device 10. In some embodiments, the legs 20 and 25 may contain one or more light sources, such as LED light strips 18, to provide back lighting for the active display panel 17. In other embodiments, the LED light strips 18 may be secured to the sides of the frame 16. The LED light strips 18 direct or tunnel light through the transparent back panel 30 to illuminate the active display panel 17. In one configuration, the LED light strips 18 may emit light that tapers off at a wavelength of about 750 nm, meaning that above 750 nm there is no significant energy in this light signal. The LED light strips 18 may emit light at a color temperature of about 5000K or about 6500K. Other color temperatures may be used in other configurations.

The transparent back panel 30 may direct or bend the light from the LED strips 18 located on the legs 20 and 25 forward towards the transparent active display panel 17. In some configurations, the back panel 30 may be made of ACRYLITE® Endlighten T, version OF11L, which appears transparent and evenly redirects light throughout the surface of the back panel 30 to provide illumination for the display 10.

Disposed below the frame 16 is an electronics housing 45 which can be used to house any electronics required for running the display such as the processor to control the active display panel 17, backlight LED strips 18, infrared light units 8, infrared camera 35, or other electronic components used within the display 10. When the LED strips 18 are turned on to illuminate the display, light tunnels from the side of the display forward towards the front panel. Stray light may also be directed back towards the IR camera 35. However, the wavelength of this light may not interfere with the IR camera's ability to capture images, as the IR camera 35 in some embodiments will not capture light at this wavelength. In one configuration, the IR camera 35 may be designed to capture light having a wavelength of about 850 nm and above.

FIG. 3 further illustrates the placement of the infrared camera 35 configured to capture images of user gestures made on the front panel 15. The infrared camera 35 may be located within the electronics housing 45 located below the frame 16. Placing the IR camera behind the display 10 results in zero camera blind spots due to the transparency of the display 10. In some configurations, the display 10 is transparent to the infrared light being reflected into the infrared camera 35 when the active display panel 17 is both active and not active. The infrared light units 8 do not interfere with the infrared camera's ability to capture user gestures on the front panel 15 of the display 10. Furthermore, the backlight LED strips 18 also do not interfere with ability of the infrared camera 35 to capture images of a user's gestures. In one configuration, the IR camera may be a CM26F272 camera having a replaceable infrared lens. In some configurations, multiple cameras may be used in order to provide a wide field of view to capture gestures made on any location of the front panel.

The placement of the infrared light units may depend on the placement of the infrared camera. Placement of the infrared camera may depend on the specifications of the infrared camera, the overall dimensions of the display device, cost, and aesthetics, among other considerations. In some embodiments, the infrared lights are placed such that infrared light is not directed directly into the infrared camera.

In some embodiments, the infrared light units may be placed on the legs 20 and 25 of the device as discussed above. This provides the advantages of a clean look to the device but may result in greater complexity due to the larger number of IR light units required, as this configurations may require multiple IR light units on each leg in order to light the entire front panel of the device.

In other embodiments, the IR light units may be placed behind the display near the infrared camera in a single module. In this configuration, both the infrared light units and the infrared camera are pointing forward towards the user and the infrared light would not be pointed directly at the infrared camera.

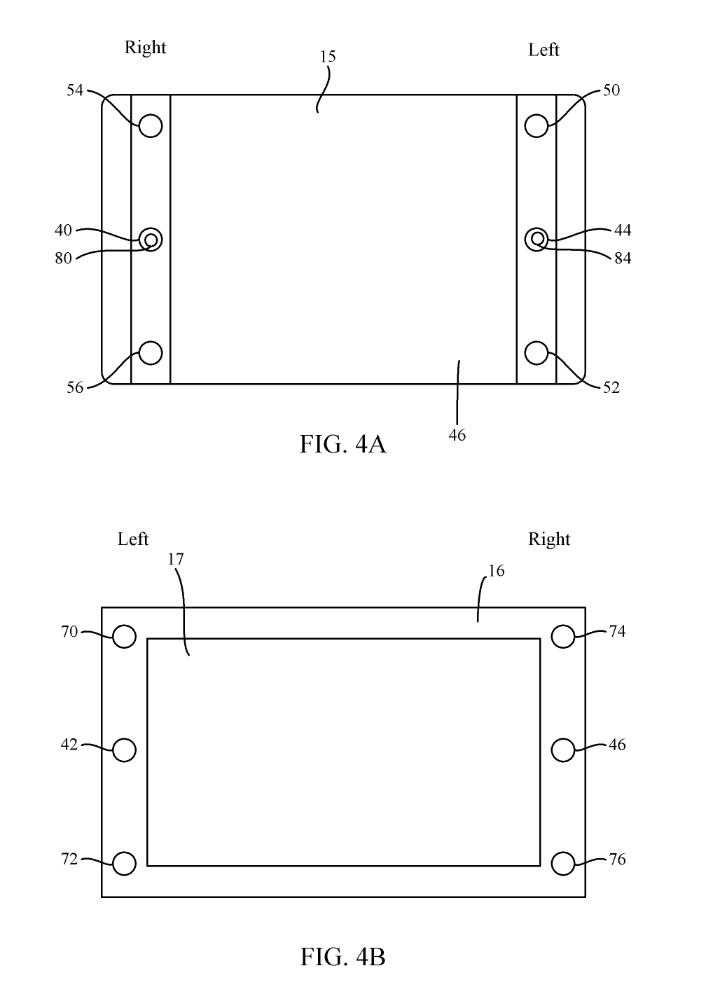

FIG. 4A schematically illustrates the underside 46 of the detachable front panel 15, that is, the side of the front panel 15 that faces the active display panel 17 when the front panel 15 is attached. The designations “Left” and “Right” in the figures refer to the orientation of the front panel 15 and the display device 10 as viewed by a user with the device 10 fully assembled with the front panel 15 attached. As shown, the front panel 15 may be detachably secured to the display device 10 by a magnetic coupling of two sets of magnet pairs. In other embodiments, more than two sets of magnet pairs may be used to secure the front panel 15 to the display device 10.

As shown in FIG. 4A, two magnets 40 and 44 are adhered to the underside of the front panel 15. The magnets 40 and 44 are preferably bonded to the underside of the front panel 15 but may be secured to the front panel 15 by other adhesion means. As shown in FIG. 4A, the magnets 40 and 44 are located at the approximate midpoint of the height of the front panel 15.

A plurality of high PSI foam members 50, 52, 54, and 56 may be located in each of the four corners of the underside 46 of the front panel 15, as shown in FIG. 4A. User pressure on the front panel 15 of the display 10 will press the high PSI foam members 50, 52, 54, and 56 against corresponding pressure sensors located on the frame 16 of the display to generate a set of pressure signals that indicate a user touch on the front panel 15. In one configuration, the high PSI foam members 50, 52, 54, and 56 may be made of an ultra-strength neoprene rubber material having a durometer of 60A and tensile strength of 2500 PSI, such as those distributed by McMaster-Carr having the manufacturers' part number 8463K412.

Low PSI foam members 80 and 84 may be bonded to each magnet 40 and 44 on the underside 46 of the front panel 15. The low PSI foam members 80 and 84 may be made of cartilage foam having a lower PSI than the high PSI foam members 50, 52, 54, and 56. In one configuration, the low PSI foam member may be cartilage material such as PORON Urethane Foam manufactured by Rogers Corporation, part number 4701-40-20062-04, having a width of 1.57 mm.

FIG. 4B schematically illustrates the active display panel 17 and the frame 16 of display 10 with the front panel 15 detached. As shown, the frame 16 surrounds all sides of the active display panel 17. In other embodiments, the frame 16 may surround the left and right sides and not the top and bottom of the active display panel 17. As discussed above, the front panel 15 may be detachably secured to the display device 10 by a magnetic coupling of two sets of magnet pairs. As shown in FIG. 4B, two magnets 42 and 46 are adhered to the frame 16 of the display device 10. The magnets 42 and 46 are preferably bonded to the frame 16 of the display device 10 but may be secured by other adhesion means. As shown, the magnets 42 and 46 are located within a central position of the sides of the frame 16. In other embodiments, low PSI foam members 80 and 84 may be secured to the magnets 42 and 46, facing the underside 46 of the front panel 15.

A plurality of pressure sensors 70, 72, 74, and 76 may be located on the legs 20, and 25 (not shown) or on the frame 16 of the display 10, near the four corners of the display panel 17. Movement of the front panel 15 with respect to the display produces a pressure signal that may be analyzed to determine the position of a user's touch and the type of user command gesture. In other embodiments, the high PSI foam members 50, 52, 54, and 56 may be bonded to the outside surface of the pressure sensors 70, 72, 74, and 76 facing the underside of the front panel 15. In one configuration, the pressure sensors 70, 72, 74, and 76 may be single-zone force sensing resistors distributed by Interlink Electronics as part number FSR 402 having a 14.7 mm diameter active area.

When the front panel 15 is detachably secured to the display device 10, the magnets 42 and 46 provide magnetic coupling of the front panel 15 to the display device when matched with the corresponding magnet 40 and 44 on the underside of the front panel 15. For example, the magnets 40, 42, 44, and 46 are oriented such that magnets 42 and 44 are magnetically attracted and magnets 40 and 46 are magnetically attracted to provide a magnetic coupling to attach the front panel 15 to the display device 10.

In other embodiments the magnet pairs may be located closer to the top or the bottom of the legs 20 and 25 of the frame 16 of the display device 10. In one configuration, the magnets may be Neodymium Disc Magnets, product number D91-N52 distributed by K&J Magnets having an attach force of 4.5 lbs. Depending on the weight of the front panel 15, magnets of varying strength or more than one set of magnets per side may be required.

The magnets 40, 42, 44, and 46 are configured to secure the front panel 15 to the display device 10 such that a small gap exists between the front panel 15 and the active display panel 17. The small gap between the front panel 15 and the active display panel 17 allows the front panel 15 to move with respect to the display panel 17 and the pressure sensors 70, 72, 74, and 76. Therefore, user pressure on the front panel 15 initiates movement of the front panel 15 which causes the high PSI foam members 50, 52, 54, and 56 to apply pressure to the corresponding pressure sensors 70, 72, 74, and 76 with varying amounts of force. The gap between the front panel 15 and the active display panel 17 also helps to prevent scratching the active display surface 17 should there be foreign material or debris on the underside of the front panel 15. The gap further helps to prevent scratches on the active display panel 17 due to general removal and placement of the front panel 15 by the user. In some configurations, the gap between the front panel 15 and the active display panel 17 may be about 3 mm. In other configurations, the gap between the front panel 15 and the active display panel may be about 2 mm or smaller.

The low PSI foam members 80 and 84 secured to one magnet of each magnet pair enable the front panel 15 to tilt and/or move toward the display panel 17 in a compressive reaction to a user touch and cushion the movement of the front panel 15 with respect to the display panel 17. The low PSI foam members 80 and 84 also act as springs to enable the front panel 15 to return to a neutral position with respect to the pressure sensors 70, 72, 74, and 76 after the release of a user's touch on the front panel 15. The low PSI foam members 80 and 84 may be bonded to either magnet of the magnet pairs that attach the front panel 15 to the display device 10. In one configuration, low PSI foam member 80 may overlay and be bonded to magnet 40 and low PSI foam member 84 may overlay and be bonded to magnet 44 on the underside of the front panel 15. In other configurations, the low PSI foam member 80 may be bonded to magnet 42 and low PSI foam member 84 may be bonded to magnet 46 positioned near the center of the legs 20 and 25 of the display device 10.

When the front panel 15 is attached to the display 15, the high PSI foam members 50, 52, 54, and 56 are aligned with the corresponding pressure sensors 70, 72, 74, and 76. User pressure on the front panel 15 of the display 10 will press the high PSI foam members 50, 52, 54, and 56 against the corresponding pressure sensors 70, 72, 74, and 76 to generate a pressure signal from each of the four sensors 70, 72, 74, and 76. These signals may be analyzed to determine a location of a user's touch on the front panel 15, as will be discussed in more detail below. The signals may also be analyzed to determine the type of user gesture made, the associated command associated with the user gesture, or to activate infrared gesture recognition, as will be discussed in greater detail below.

As will be discussed in further herein, a processor receives the signals from the pressure sensors 70, 72, 74, and 76 and associates the pressure signals with a user gesture. The sensors are configured to be able to determine the location of pressure from a user touch on the front panel based on relative pressure differentials between the sensors. The pressure sensors 70, 72, 74, and 76 represent one means for receiving user input on the front panel 15 of the touch sensitive display device 10.

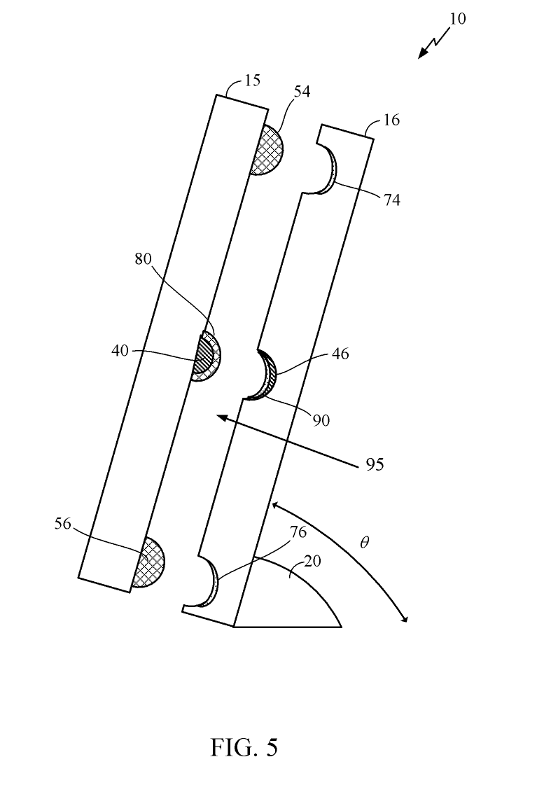

A cross sectional view of the display device 10 is shown in FIG. 5. This view shows a cross section through the magnets and pressure sensors located on the right side of the display device 10. In this figure, magnets 40 and 46 are paired to secure the front panel 15 to the display device 10. The low PSI foam member 80 is sandwiched between the magnets 40 and 46 to act a spring to return the front panel 15 to a neutral position after the release of pressure from a user's touch. FIG. 5 depicts one low PSI foam member 80; however, the corresponding foam member 84 (not shown) is located on the opposite side (the left side) of the display 10.

In some embodiments, a high friction material such as sand paper may be provided between the magnets of each pair to hold the front panel 15 securely to the display device 10 with minimal or no slipping. In some configurations, the high friction film or sand paper may be secured between the magnet attached to the frame or leg and the low PSI foam member attached to the magnet secured to the underside 46 of the front panel 15. This high friction film prevents the frontal glass from sliding down or from side to side. As shown in FIG. 5, a high friction film member 90 is further sandwiched between the magnets 40 and 46 to minimize downward or side to side slippage of the front panel 15. In some configurations, the high friction material may be sandpaper such as Norton Tufbak Gold T481 having 220 A-WT. This high friction material may stand up to repeated washings over time as the front panel 15 is washed. In addition, this material is rough enough to grip the low PSI foam member without ripping the foam member.

Correspondingly, on the other side of the display (not shown), magnets 42 and 44 are paired help hold the front panel 15 to the display device 10, with low PSI foam member 84 and a second high friction film member 90 sandwiched between the magnets 42 and 44. The low PSI foam members 80 and 84 act as grip surfaces for the high friction material 90 to “bite” into as the magnets 40, 42, 44, and 46 compress the foam and film.

A gap 95 between the front panel 15 and the frame 16 may be seen more clearly in FIG. 5. The gap 95 allows the front panel 15 to move with respect to the frame 16 and active display panel 17 in response to the pressure from a user's touch.

The high PSI foam members 54 and 56 are aligned with the pressure sensors 74 and 76, as shown in FIG. 5. The movement of the front panel 15 with respect to the display 10 will press the high PSI foam member against the corresponding pressure sensor, and trigger a pressure signal from each pressure sensor. Movement of the front panel 15 may cause the high PSI foam member to press against the corresponding pressure sensor or may cause the high PSI foam member to release from the corresponding pressure sensor.

For example, when a user touches the top right quadrant of the display, the top right corner of the front panel 15 will move towards the frame 16, pressing high PSI foam member 54 against the pressure sensor 74. The rigidity of the front panel 15 will cause the lower right corner of the front panel 15 to lift away from the frame 16. Movement of the front panel 15 in response to pressure from a user's touch will result in different responses from the pressure sensors on each side of the display 10. These responses may be analyzed to determine a location of the user's touch on the front panel 15 and may be correlated to a specific application or window active at the position of the user's touch in order to perform the desired command within the user-selected application.

### Infrared Gesture Capture Feature Overview

In one embodiment of the invention, interactive user gestures may be captured on the touch-sensitive display device using the infrared camera and infrared light units to visually analyze the user's gestures. The applied pressure of a user's touch on the front panel of the display, as measured by at least one pressure sensor mounted to the display, indicates the start of an interactive gesture and may be used to activate a gesture processing module housed within a processor connected to the display device. Likewise, the release of pressure from the touch-sensitive display indicates of the end of an interactive gesture.

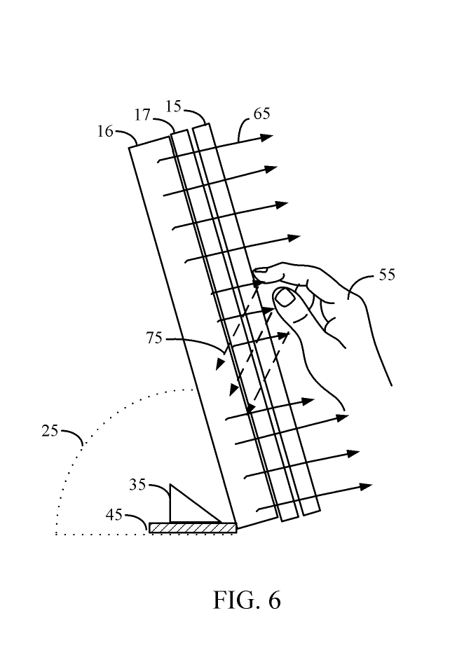

FIG. 6 illustrates one embodiment of infrared image capture of a user's gestures. The infrared camera 35 attached to electronics housing 45 can capture an image of the interactive gesture for analysis by the gesture recognition module of the processor. In one configuration, user pressure on the front panel 15, as registered by at least one of the pressure sensors (not shown), may trigger illumination of the infrared light 65 from infrared lights on the frame 16 and activation of infrared camera 35.

The infrared light, indicated by solid lines 65, may pass through the transparent active display panel 17 and the front panel 15. The infrared camera 35 may be placed at an optimal location behind the display in order to capture infrared reflections 75 from a user's finger 55. The infrared camera 35 can see through the transparent active display panel 17 when the display panel 17 is both active and inactive to capture images of a user gesture. The release of pressure from the front panel 15, as determined by the pressure sensors, may signal the end of infrared gesture recognition functions and may trigger the infrared light units to be turned off.

### Infrared Gesture Interaction System Overview

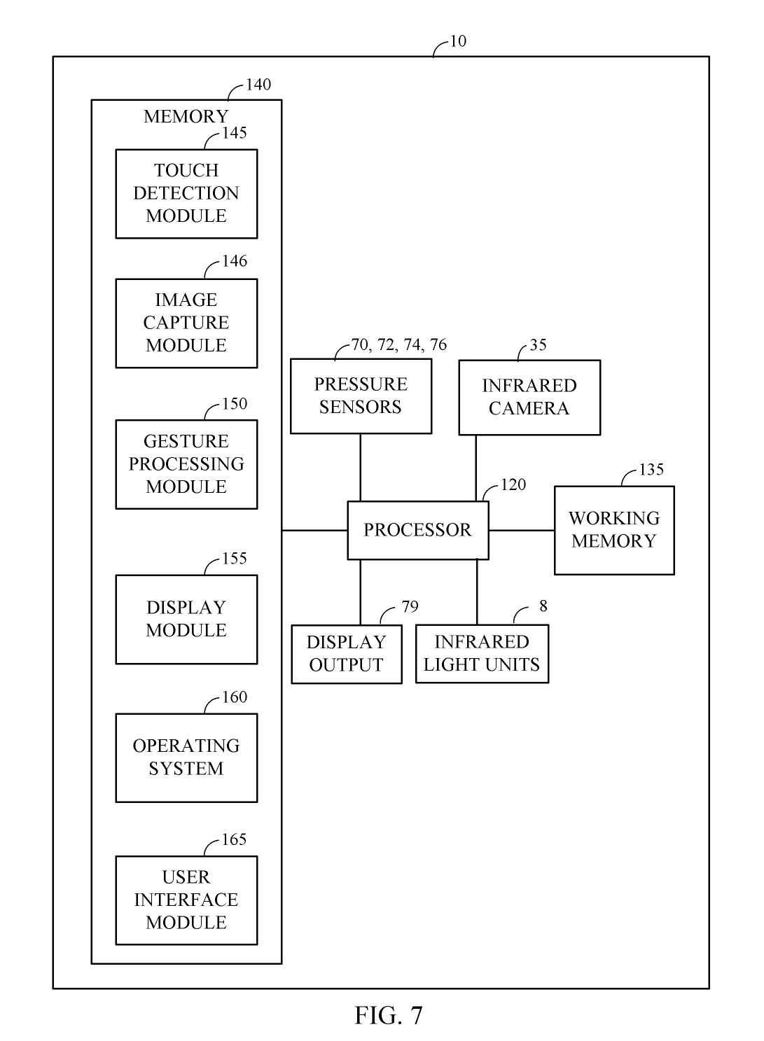

A high-level block diagram of one embodiment of the touch sensitive display device 10 configured with infrared gesture recognition is shown in FIG. 7. The touch sensitive display system 10 may be incorporated into the electronics housing 45 to control the functions of the display such as active display panel, backlight LED strips, infrared light units 8, infrared camera 35, or other electronic components used within the display 10. As shown, the system 10 has a set of components including a processor 120 linked to a plurality of pressure sensors 70, 72, 74, and 76 and a display output 79. The infrared camera 35 and infrared light units 8 are also linked to processor 120. A working memory 135 and memory 140 are also in communication with processor 120. The touch sensitive display system 10 may also connect to a computer in order to provide additional applications and functions for the display, such as word processing, video and audio functions, or interactive browsing via the Internet.

Touch sensitive display system 10 may be a stationary device such as a display built into a kitchen cabinet unit, refrigerator, or other appliance or it may be a standalone display unit. A plurality of applications may be available to the user on touch sensitive display system 10 via an attached computer system. These applications may include but are not limited to calendar viewing and editing functions, word processing functions, recipe editing and viewing functions, video and imaging display functions, and internet browsing functions.

Processor 120 may be a general purpose processing unit or a processor specially designed for display applications. As shown, the processor 120 is connected to a memory 140 and a working memory 135. In the illustrated embodiment, the memory 140 stores a touch detection module 145, an image capture module 146, a gesture processing module 150, a display module 155, operating system 160, and user interface module 165. These modules may include instructions that configure the processor 120 to perform various display, touch sensing, image capture, and gesture processing functions and device management tasks. Working memory 135 may be used by processor 120 to store a working set of processor instructions contained in the modules of memory 140. Alternatively, working memory 135 may also be used by processor 120 to store dynamic data created during the operation of touch sensitive display system 10.

As mentioned above, the processor 120 is configured by several modules stored in the memory 140. Touch detection module 145 includes instructions that configure the processor 120 to detect a user's touch on the front panel 15 of the display 10 by analyzing the signals received from the pressure sensors 70, 72, 74, and 76. Therefore, processor 120, along with touch detection module 145 and pressure sensors 70, 72, 74, and 76 represent one means for detecting a user's touch on the front panel 15 of the display device 10.

The image capture module 146 provides instructions that configure the processor 120 to capture an image of a user's gestures made on the front panel 15 of the display 10 using the infrared camera 35. A user's touch on the front panel 15 may trigger the initiation of infrared image capture functions, while a user's release of pressure from the front panel 15 may trigger the cessation of infrared image capture functions.

The gesture processing module 150 provides instructions that configure the processor 120 to process the pressure sensor data and the captured images to determine the intended meaning of the touch and/or gesture. The gesture processing module 150 can perform a variety of functions on the received images, including, for example, color signal processing, analog-to-digital conversion and/or gamma correction. The gesture processing module 150 can receive a sequence of images from the camera 35 containing a hand or finger of the user, and the gesture processing module 150 can be configured to invert each image to generate a mirrored image. The gesture processing module 150 can use the inverted and/or non-inverted image to perform additional processing tasks, such as gesture pattern matching or feature extraction. The data can also be stored as image data within the memory 140. Therefore, processor 120, along with touch detection module 145, image capture module 146, pressure sensors 70, 72, 74, and 76, infrared camera 35, and gesture processing module 150 represent one means for determining the intended meaning of a user's touch.

The gesture processing module 150 can combine processed or unprocessed images to form combined images. The gesture processing module 150 can further perform feature extraction functions to process the sequence of images to determine areas of motion. For example, the gesture processing module 150 can compare a received frame to a frame earlier in the capture sequence, such as the immediately preceding frame, and compute a difference image between the frames. The difference image can be filtered in any suitable manner, including, for example, by removing difference below a threshold so as to produce a filtered difference image. The filtered and/or unfiltered difference images can be stored as image data in the memory 140.

The start point of a gesture can be determined by first computing the geographic position of the initial screen touch by the user relative to the display screen. The gesture processing module 150 may determine the relative pressure from each pressure sensor communicating with the transparent panel and from that data determine the two-dimensional position of the user's touch relative to the display panel. That determination can provide additional focus to the gesture determination by the infrared camera by becoming a start point of the gesture as determined by the system. By aligning the detected initial touch position with IR capture, the gesture processing module can determine the start and movement of the gesture over time.

An endpoint of a user gesture can also be determined by the gesture processing module 150. The gesture processing module 150 can analyze the sequence of difference images to determine a gesture endpoint or the gesture endpoint can be determined from a release of user pressure on the front panel 15. For example, the gesture processing module 150 can be configured to locate one or more frames having a relative low motion detected after a sequence of one or more frames containing a relatively high motion. Upon determined that a gesture endpoint has been detected, the gesture processing module 150 can use the information to determine whether the gesture matches one or more known gesture patterns. For example, the sequence of gesture images can be compared against each gesture template stored in memory 140 to determine if a recognized gesture has occurred.

The user interface module 165 may include instructions that configure the processor 120 to display information on the active display panel 17 of the display device 10.

The various modules can be implemented in various combinations of hardware and/or software. For example, the touch detection module 145, the image capture module 146, the gesture processing module 150, the display module 155, and the user interface module 165 can be implemented as instructions stored on a computer readable storage medium configured to execute using one or more processors. Additional details regarding the implementation of the modules will be described in detail later below.

Operating system 160 configures the processor 120 to manage the memory and processing resources of system 10. For example, operating system 160 may include device drivers to manage hardware resources such as the display output, pressure sensors 70, 72, 74, and 76, and infrared camera 35. Therefore, in some embodiments, instructions contained in the touch sensitive display system modules discussed above may not interact with these hardware resources directly, but instead interact through standard subroutines or APIs located in operating system component 160. Instructions within operating system 160 may then interact directly with these hardware components.

Although FIG. 7 depicts a device comprising separate components to include a processor, a plurality of pressure sensors, electronic display output, and memory, one skilled in the art would recognize that these separate components may be combined in a variety of ways to achieve particular design objectives. For example, in an alternative embodiment, the memory components may be combined with processor components to save cost and improve performance.

Additionally, although FIG. 7 illustrates two memory components, including memory component 140 comprising several modules and a separate memory 135 comprising a working memory, one with skill in the art would recognize several embodiments utilizing different memory architectures. For example, a design may utilize ROM or static RAM memory for the storage of processor instructions implementing the modules contained in memory 140. Alternatively, processor instructions may be read at system startup from a disk storage device that is integrated into touch sensitive display system 10 or connected via an external device port. The processor instructions may then be loaded into RAM to facilitate execution by the processor. For example, working memory 135 may be a RAM memory, with instructions loaded into working memory 135 before execution by the processor 120.

### Infrared Gesture Interaction Overview

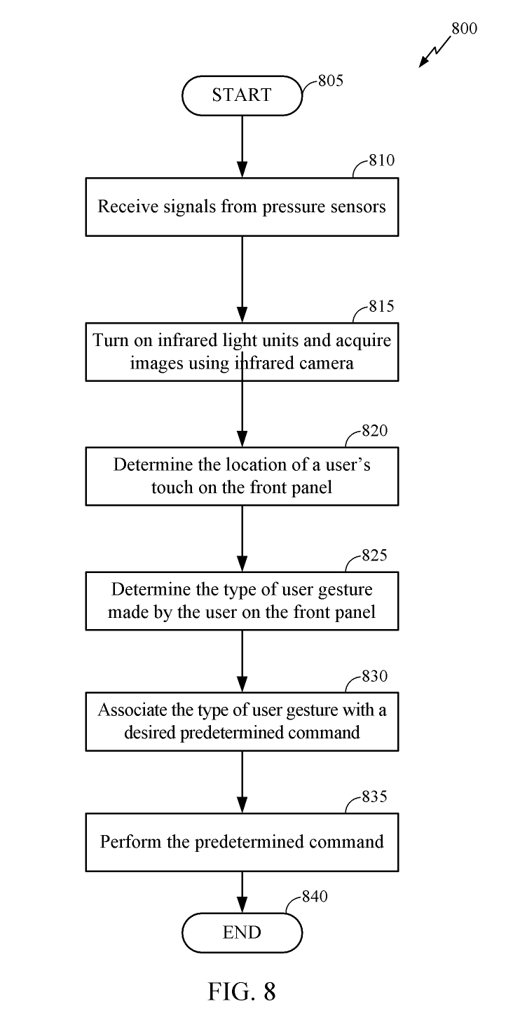

FIG. 8 is a high-level flow chart illustrating a process 800 that depicts an overview of an infrared gesture capture and recognition process that may be implemented on a touch-sensitive electronic display such as display device 10. Process 800 may be used in some embodiments to capture an image or a series of images of a user's gestures made on the front panel 15 of a display device 10 and interpret this image or images as a commanded user gesture.

The process 800 begins at start block 805 and transitions to block 810 wherein one or more of the pressure sensors transmit a pressure signal to indicate that a user has placed their hand or finger on the front panel of the display. Depending on the position of the user's touch on the front panel, the signals from the pressure sensors may vary. The user's touch on the front panel may cause the front panel to deflect toward the active display panel attached to the frame of the display. This deflection in turn causes the pressure sensors to be engaged to varying degrees by the corresponding high PSI foam members.

The insertion of the low PSI foam members between each of the magnet pairs that secure the front panel to the display device, along with the small gap between the front panel and the active display panel, allow the front panel to deflect up and down. The position of a user's touch on either side of a center line passing vertically through the center of a the display device also may cause the front panel to deflect more to one side than the other, therefore causing a greater pressure signal response in the pressure sensor located closer to the area of the user's touch on the front panel. Similarly, a user's touch on any of the four quadrants of the front panel will result in a higher pressure sensor response from the sensor closest to the area of the user's touch.

Process 800 then transitions to block 815 wherein the infrared light units are instructed to turn on in response to the pressure signal indicating a user touch on the front panel. Simultaneously, the infrared camera is instructed to begin acquiring one or more images of the user's gestures made on the front panel of the display device.

After the infrared light units and the infrared camera have been turned on, process 800 transitions to block 820, wherein the location of the user's touch on the front panel is determined. For each user touch or gesture, the duration of the touch, the direction or path of any movement of the touch, and any acceleration of movement of the touch may be determined. The location of the user's touch may be determined from the magnitude of the pressure signals received by the processor and the known locations and distances between each of the plurality of pressure sensors. The location of the user's touch may indicate the context of the user's interaction with the display device. For example, the location of the user's touch may indicate that the user is interacting with an internet browser window or with a text editing application, depending on the displayed location of each application on the display device.

After determining the location of a user's touch on the front panel and acquiring at least one image of a user gesture, process 800 transitions to block 825 wherein the type of user gesture made by the user on the front panel is determined. The type of user gesture may be determined by comparing the image of a user's gesture or a combined image formed from a series of images of the user's gesture with a library or catalog of user gestures contained within a memory unit.

Once the type of user gesture has been determined, process 800 transitions to block 830 wherein the user gesture is associated with a desired predetermined command. For example, the user could perform a swipe action at one location on the front panel and the system would associate the performed action with moving an object on the active display panel. Other actions, including multi-touch gestures, are also possible, such as opening or closing an application, resizing an object, selecting an object, or entering text on a virtual keyboard, among other actions.

After associating the type of user gesture with a desired predetermined command, process 800 transitions to block 835 wherein the system performs the predetermined command. As discussed in the above example, the system may open or close an application, resize an object, select an object, or enter text into an application, among other actions, in response to a gesture associated with a predetermined command. Once the predetermined command has been executed, process 800 transitions to block 840 and ends.

### Infrared Gesture Capture and Recognition Overview

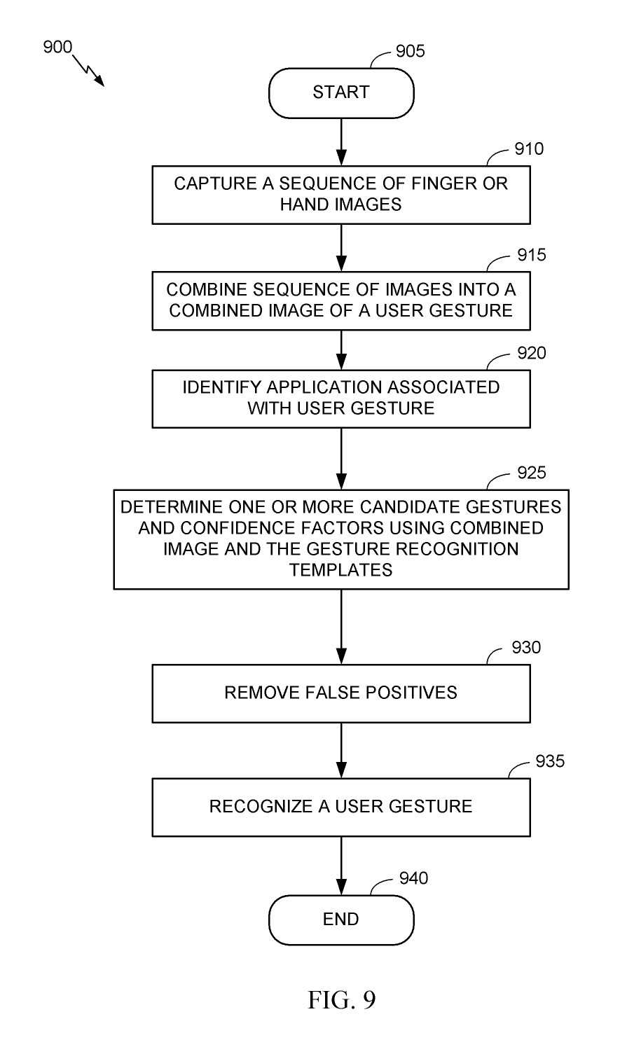

FIG. 9 is a flow chart of a process 900 for recognizing and processing multi-touch or complex user gestures captured using an infrared camera in accordance with one embodiment. The process 900 starts at a start block 905 and transitions to block 910 wherein the system captures a sequence of finger or hand images made on the front panel of a display. Image capture begins when a user asserts pressure on the front panel of the display device with a hand or finger.

As discussed above, pressure on the touch-sensitive display, as registered by one or more pressure sensors, triggers the infrared light units to be turned on and image capture by the infrared camera to begin. The termination of image capture and the completion of a complex, multi-touch gesture is indicated when the user removes pressure from front panel of the display by lifting his/her hand or finger. Upon the release of pressure from the front panel, the infrared light units may be turned off and image capture by the infrared camera ends.

The process 900 then transitions to block 915 wherein the sequence of images is combined into a single image of a complex user gesture using image processing functions. The process 900 then transitions to block 920 wherein the application associated with the user input is identified. The application may be identified based on the known location of the application interface on the display device and a known location of the user's touch, as identified by one or more of the pressure sensors.

Process 900 next transitions to block 925 wherein one or more candidate gestures and confidence factors are determined using the combined image of the user gesture. For example, a gesture recognition template can be compared to the captured image or images. The comparison of the each gesture recognition template to the captured image or images can result in one or more potential gesture matches. Each potential gesture match can be assigned a confidence factor based on a similarity of the gesture recognition template to the captured image or images. Potential gesture matches of a sufficient confidence factor, such as a potential gesture match over a threshold confidence level, can be determined to be a candidate gesture. The candidate gestures and the corresponding confidence factors determined using each gesture recognition template can collectively form a list of candidate gestures and confidence factors.

After determining a list of candidate gestures and confidence factors, process 800 then transitions to block 930 wherein false positives are removed. For example, removing false positives can include removal of one or more candidate gestures from the list of candidate gestures using a global motion condition, a local motion condition, and/or one or more confidence factors. A candidate gesture that is not removed as being a false positive can be determined to be the recognized gesture in the subsequent block 935 of process 900. Process 900 then transitions to block 940 and ends.

### Clarification Regarding Terminology

Those having skill in the art will further appreciate that the various illustrative logical blocks, modules, circuits, and process steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. One skilled in the art will recognize that a portion, or a part, may comprise something less than, or equal to, a whole. For example, a portion of a collection of pixels may refer to a sub-collection of those pixels.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, camera, or other device.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A touch-sensitive display device, comprising:
a touchscreen having a front and a back and capable of detecting a user's touch;
one or more infrared lights configured to illuminate a user's finger placed in front of the touchscreen;
an infrared camera positioned behind the touchscreen and configured to capture infrared images of a user's finger through the touchscreen; and
a gesture processing module configured to determine a user's touch on the touchscreen and track the position of the user's finger, wherein the gesture processing module determines a user's gesture from the determined touch and position tracking.

2. The display of claim 1, wherein the touchscreen is mounted on a frame structure.

3. The display of claim 2, wherein the touchscreen comprises a first panel mounted on the frame structure and configured to display information and a second panel detachably secured to the first panel and configured to cover the first panel.

4. The display of claim 3 further comprising at least one pressure sensor coupled to the frame structure and configured to determine a location of a user's touch on the second panel.

5. The display of claim 3, wherein the second panel is detachably secured to the first panel by a plurality of magnets.

6. The display of claim 3, wherein the infrared lights are coupled to the frame structure behind the first and second panels and configured to direct light through the first and second panels towards a user of the display.

7. The display of claim 3, wherein the infrared camera is coupled to the frame structure behind the first and second panels.

8. The display of claim 4, wherein the infrared lights are configured to be turned on in response to a touch event on the second panel.

9. A system to capture user gestures on a touch-sensitive display device, comprising:
a touchscreen having a front and back and capable of detecting a user's touch, one or more infrared lights configured to illuminate a user's finger placed in front of the touchscreen, and an infrared camera positioned behind the touchscreen and configured to capture infrared images of a user's finger through the touchscreen;
a control module configured to:
activate a gesture recognition module when a user touches the touchscreen;
capture one or more images of user gestures made on the touchscreen of the touch-sensitive display device;
deactivate the gesture recognition module when a user releases the touchscreen; and
analyze the images of user gestures to perform a corresponding action on the display.

10. The system of claim 9, wherein the touchscreen is mounted on a frame structure.

11. The system of claim 10, wherein the touchscreen comprises a first panel mounted on the frame structure and configured to display information and a second panel detachably secured to the first panel and configured to cover the first panel.

12. The system of claim 9, wherein the control module is further configured to query a memory for a user command associated with the images of the user gestures.

13. The system of claim 12, wherein the control module is further configured to execute the user command via a processor.

14. The system of claim 12, wherein the query for the user command associated with the images of the user gestures is based on an identified gesture pattern.

15. A touch-sensitive display device, comprising:
a touchscreen having a front and a back and capable of detecting a user's touch;
means for providing an infrared light when a user touches the touchscreen;
means for capturing one or more images of a user's gestures made on the touchscreen of the touch-sensitive display device;
means for deactivating the infrared light and discontinuing capture of images of user gestures when a user releases the touchscreen; and
means for analyzing the images of user gestures to perform a corresponding action on the display.

16. The device of claim 15, wherein the means for capturing one or more images comprises an infrared camera.

17. The device of claim 15, wherein the means for providing infrared light comprises one or more infrared light sources configured to shine light through the touchscreen.

18. A method for inputting data into a touch-sensitive electronic device, the method comprising:
detecting pressure from a user touch on the touch-sensitive device;
activating an infrared light unit when a user touch is detected;
capturing one or more images of a user gestures made on the touch-sensitive display device; and
analyzing the images of user gestures to perform a corresponding action on a display of the touch-sensitive electronic device.

19. The method of claim 18, wherein analyzing the images of user gestures comprises comparing the images to each of a plurality of gesture recognition templates to identify at least one candidate gesture.

20. The method of claim 19 further comprising assigning a confidence factor to each candidate gesture.

21. The method of claim 20, wherein analyzing the gesture comprises selecting a gesture from the at least one candidate gesture having the greatest confidence factor.

22. A non-transitory computer-readable storage medium comprising instructions that when executed by a processor perform a method of inputting data into a touch-sensitive electronic device, the method comprising:
detecting pressure from a user touch on the touch-sensitive device;
activating an infrared light unit when a user touch is detected;
capturing one or more images of a user gestures made on the touch-sensitive display device; and
analyzing the images of user gestures to perform a corresponding action on a display of the touch-sensitive electronic device.

23. The computer-readable storage medium of claim 22, wherein analyzing the images of user gestures comprises comparing the images to each of a plurality of gesture recognition templates to identify at least one candidate gesture.
